(19) United States
(12) Patent Application Publication
(10) Pub. No.: US 2026/0229571 A1
(43) Pub. Date: Aug. 6, 2026

(54) SURFACE PROTONATED HYDROCARBON SUPPORTS FOR FUEL CELL AND ELECTROLYZER MEMBRANES

(71) Applicant: GM Global Technology Operations LLC, Detroit, MI (US)

(72) Inventor: Ruichun Jiang, Troy, MI (US)

(21) Appl. No.: 19/045,783

(22) Filed: Feb. 5, 2025

(51) Int. Cl. H01M 8/1004; C25B 9/23; C25B 11/032; C25B 13/08; H01M 8/1053

(52) U.S. Cl. CPC H01M 8/1004; C25B 9/23; C25B 11/032; C25B 13/08; H01M 8/1053; H01M 2250/20

(57) ABSTRACT

Aspects of the disclosure include surface protonated hydrocarbon supports for fuel cell and electrolyzer membranes. An exemplary proton exchange membrane (PEM) electrochemical cell includes a proton-generating electrode having an anode, a proton-consuming electrode including a cathode, and a proton exchange membrane positioned between the proton-generating electrode and the proton-consuming electrode. The proton exchange membrane further includes a surface protonated porous hydrocarbon reinforcement layer. The surface protonated porous hydrocarbon reinforcement layer can include a non-fluorinated or partially fluorinated hydrocarbon support matrix with surface protonation. The surface protonated porous hydrocarbon reinforcement layer can be protonated by a chemical reaction process, such as a sulfonation process, using at least one of an acid or a sulfonation reagent, or protonated by a physical treatment process, such as an immersing process in the presence of a diluted ionomer solution.

The present disclosure relates to hydrogen fuel cells and electrolysis, and particularly to surface protonated hydrocarbon support structures for fuel cell and electrolyzer membranes.

Hydrogen fuel cells and related technologies have emerged as a promising clean energy solution, offering high efficiency and zero emissions for various applications ranging from transportation (e.g., personal and commercial vehicles, shipping, aircraft, etc.) to stationary power generation. In a hydrogen fuel cell, hydrogen enters through an anode, where it's split into protons and electrons. The protons pass through an electrolyte membrane, while electrons flow through an external circuit, generating electricity. At the cathode, protons, electrons, and oxygen combine to produce water. Hydrogen fuel cells are typically implemented in fuel cell stacks—assemblies of multiple individual hydrogen fuel cells connected in series to increase overall voltage and power output.

Hydrogen fuel cells require a supply of hydrogen fuel that is typically provided via one or more electrolysis cells. An electrolysis cell is a device that uses electrical energy to drive a non-spontaneous chemical reaction that splits water (H₂O) into hydrogen (H₂) and oxygen (O₂) gases. An electrolysis cell typically includes an anode, a cathode, and an electrolyte. When an electric current is applied between the anode and cathode, water molecules are split at the anode to produce oxygen gas and protons (H⁺), while at the cathode, protons combine with electrons to produce hydrogen gas.

### SUMMARY

In one exemplary embodiment a vehicle includes an electric motor, a battery, and a fuel cell stack including proton exchange membrane (PEM) electrochemical cells. The fuel cell stack is electrically coupled to at least one of the electric motor or the battery. The PEM electrochemical cell includes a proton-generating electrode (an anode), a proton-consuming electrode (a cathode), and a proton exchange membrane positioned between the anode and the cathode. The proton-generating electrode, proton-consuming electrode, and proton exchange membrane collectively defining a membrane-electrode-assembly (MEA). The proton exchange membrane includes a surface protonated porous hydrocarbon reinforcement layer. The PEM electrochemical cell further includes an anode-side gas diffusion layer on the proton-generating electrode, a cathode-side gas diffusion layer on the proton-consuming electrode, a first flow field coupled to the anode-side gas diffusion layer, and a second flow field coupled to the cathode-side gas diffusion layer.

In some embodiments, the surface protonated porous hydrocarbon reinforcement layer includes a non-fluorinated or partially fluorinated hydrocarbon support matrix with surface protonation.

In some embodiments, the surface protonated porous hydrocarbon reinforcement layer includes at least one of sulfonated poly(ether-ether-ketone) (SPEEK) and polysulfone (PSU).

In some embodiments, the non-fluorinated or partially fluorinated hydrocarbon support matrix is protonated by a sulfonation process using at least one of an acid or a sulfonation reagent.

In some embodiments, the non-fluorinated or partially fluorinated hydrocarbon support matrix is protonated by an immersing process in the presence of a diluted ionomer solution.

In some embodiments, the proton exchange membrane (PEM) includes a bottom ionomer layer, a top ionomer layer, and an ionomer filled porous support layer between the bottom ionomer layer and the top ionomer layer.

In some embodiments, the ionomer filled porous support layer includes a porous hydrocarbon matrix, and ionomer filled in the matrix.

In another exemplary embodiment a PEM electrochemical cell includes a proton-generating electrode comprising an anode, a proton-consuming electrode comprising a cathode, and a proton exchange membrane positioned between the proton-generating electrode and the proton-consuming electrode. The proton-generating electrode, proton-consuming electrode, and proton exchange membrane collectively define an MEA. The proton exchange membrane further includes a surface protonated porous hydrocarbon reinforcement layer. The PEM cell includes an anode-side gas diffusion layer on the proton-generating electrode, a cathode-side gas diffusion layer on the proton-consuming electrode, a first flow field coupled to the anode-side gas diffusion layer, and a second flow field coupled to the cathode-side gas diffusion layer.

In some embodiments, the surface protonated porous hydrocarbon reinforcement layer includes a non-fluorinated or partially fluorinated hydrocarbon support matrix with surface protonation.

In some embodiments, the surface protonated porous hydrocarbon reinforcement layer includes at least one of SPEEK and PSU.

In some embodiments, the non-fluorinated or partially fluorinated hydrocarbon support matrix is protonated by a sulfonation process using at least one of an acid or a sulfonation reagent.

In some embodiments, the non-fluorinated or partially fluorinated hydrocarbon support matrix is protonated by an immersing process in the presence of a diluted ionomer solution.

In some embodiments, the PEM includes a bottom ionomer layer, a top ionomer layer, and an ionomer filled porous support layer between the bottom ionomer layer and the top ionomer layer.

In some embodiments, the ionomer filled porous support layer includes a porous hydrocarbon matrix, and ionomer filled in the matrix.

In yet another exemplary embodiment a method can include forming a proton-generating electrode comprising an anode, forming a proton-consuming electrode comprising a cathode, and forming a proton exchange membrane positioned between the proton-generating electrode and the proton-consuming electrode. The proton-generating electrode, proton-consuming electrode, and proton exchange membrane collectively define an MEA. The proton exchange membrane includes a surface protonated porous hydrocarbon reinforcement layer. The method includes forming an anode-side gas diffusion layer on the proton-generating electrode, forming a cathode-side gas diffusion layer on the proton-consuming electrode, coupling a first flow field to the anode-side gas diffusion layer, and coupling a second flow field to the cathode-side gas diffusion layer.

In some embodiments, the surface protonated porous hydrocarbon reinforcement layer includes a non-fluorinated or partially fluorinated hydrocarbon support matrix with surface protonation.

In some embodiments, the surface protonated porous hydrocarbon reinforcement layer includes at least one of SPEEK and PSU.

In some embodiments, the non-fluorinated or partially fluorinated hydrocarbon support matrix is protonated by a sulfonation process using at least one of an acid or a sulfonation reagent.

In some embodiments, the non-fluorinated or partially fluorinated hydrocarbon support matrix is protonated by an immersing process in the presence of a diluted ionomer solution.

In some embodiments, the PEM includes a bottom ionomer layer, a top ionomer layer, and an ionomer filled porous support layer between the bottom ionomer layer and the top ionomer layer.

In some embodiments, the ionomer filled porous support layer includes a porous hydrocarbon matrix, and ionomer filled in the matrix.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A depicts an electrolyzer in accordance with one or more embodiments;

FIG. 2B depicts a fuel cell in accordance with one or more embodiments;

FIG. 3A depicts a protonation process for forming a protonated support matrix for fuel cell and electrolyzer membranes in accordance with one or more embodiments;

FIG. 3B depicts an example reaction for a protonation process in accordance with one or more embodiments;

FIG. 4 depicts a process for fabricating a proton exchange membrane (PEM) using surface protonated hydrocarbon supports and ionomer solution, for fuel cell and electrolyzer membranes in accordance with one or more embodiments; and

FIG. 5 is a flowchart in accordance with one or more embodiments.

### DETAILED DESCRIPTION

The following description is merely exemplary in nature and is not intended to limit the present disclosure, its application or uses.

Understanding and optimizing proton exchange membrane (PEM) type electrochemical cells, such as hydrogen fuel cells and electrolysis cells (also referred to as electrolyzers), has become crucial for widespread adoption and commercialization of hydrogen fuel cell technologies. One of the key components in PEM type electrochemistry cells is the membrane electrode assembly (MEA). In a PEM cell, the MEA serves as the core functional unit where the primary electrochemical reactions occur, converting chemical energy into electrical energy (in fuel cells) or electrical energy into chemical energy (in electrolysis cells). More specifically, in a PEM fuel cell, the MEA facilitates the oxidation of hydrogen at the anode and the reduction of oxygen at the cathode, generating electricity along with byproduct water, while in a PEM electrolysis cell, the MEA facilitates the splitting of water into hydrogen and oxygen gases by use of electricity.

Despite their potential, optimizing the design and fabrication of PEMs and MEAs remains challenging. For example, ensuring mechanical stability without degrading performance remains unsolved. To illustrate, consider that these membranes often incorporate support layers made from materials like expanded polytetrafluoroethylene (ePTFE) or hydrocarbon substructures to enhance mechanical stability. Unfortunately, these materials, while suitable for providing mechanical reinforcement, are inert in the sense that they do not conduct protons, which can negatively impact the overall proton conductivity of the membrane. This reduction in proton conductivity can lead to decreased performance and efficiency of the underlying fuel cells and electrolyzers, limiting their commercial viability and widespread adoption.

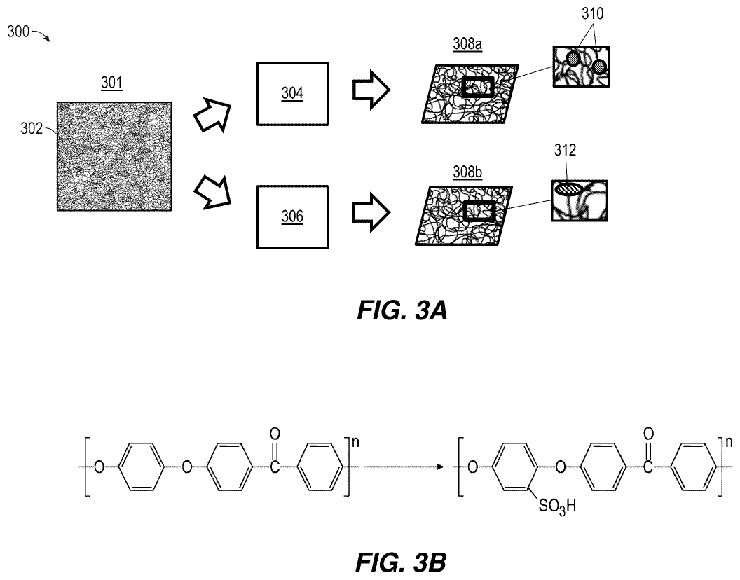

This disclosure introduces the fabrication and use of surface protonated hydrocarbon support structures for fuel cell and electrolyzer membranes. The designs described herein aim to improve both the mechanical stability and proton conductivity of proton exchange membranes, thereby optimizing the performance of fuel cells and electrolyzers. Surface protonation can be achieved by different processes such as sulfonation by concentrated acid(s) and/or other reagents (refer to FIG. 3A step 304 and FIG. 3B) and/or via a pre-treatment of support materials using a diluted ionomer solution immersion (refer to FIG. 3A step 306). These methods increase the proton density on the surface of the support materials, facilitating better ionomer imbibement and improving the overall proton conductivity of the membranes.

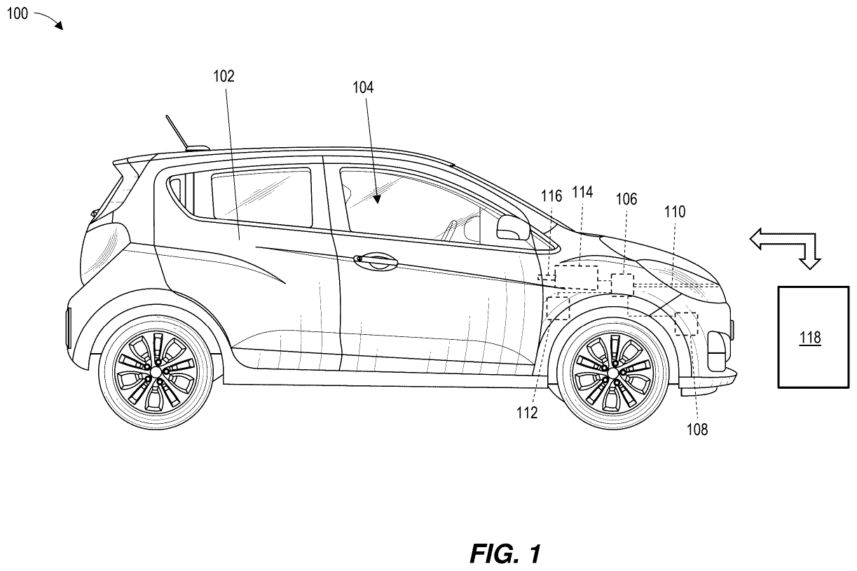

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, a fuel cell 106 (also referred to as a “fuel cell stack”), a hydrogen fuel storage tank 108, an air intake manifold 110, a battery 112, and an electric motor 114 configured for utilizing electrical energy to provide an output torque to an output component 116 (each shown by projection near the front of the vehicle 100). Fuel cell 106 receives a flow of hydrogen or other fuel gas from the hydrogen fuel storage tank 108 and receives a flow of air including oxygen gas from air intake manifold 110. The fuel cell 106 may include an air compressor device (not separately indicated) useful to pressurize the air to a desired pressure. The fuel cell 106 may provide electrical energy directly to the electric motor 114 and/or the fuel cell 106 may provide electrical energy to the battery 112 for storage and later use. The output component 116 may provide the output torque for usage, for example, to provide a motive force to the vehicle 100. In some embodiments, vehicle 100 receives hydrogen fuel from an electrolyzer 118 (electrolysis cells) configured to produce and, in some embodiments, deliver hydrogen to the hydrogen fuel storage tank 108 and/or fuel cell 106.

The fuel cell 106, hydrogen fuel storage tank 108, air intake manifold 110, battery 112, electric motor 114, and electrolyzer 118 are shown for ease of illustration and discussion only. It should be understood that the configuration, location, size, arrangement, etc., of these components is not meant to be particularly limited, and all such configurations (including multi-motor configurations) are within the contemplated scope of this disclosure. Moreover, while the present disclosure is discussed primarily in the context of a fuel cell 106 and electrolyzer 118 configured for the vehicle 100, aspects described herein can be similarly incorporated within any system (vehicle, building, or otherwise) having a hydrogen fuel cell-based power and/or energy storage system(s), and all such configurations and applications are within the contemplated scope of this disclosure. In particular, the electrolyzer 118 can be configured as an entirely separate unit for standalone hydrogen and oxygen production (perhaps for serving vehicle 100 and/or other downstream applications). As will be discussed in greater detail herein, the fuel cell 106 and/or electrolyzer 118 can be modified to include surface protonated hydrocarbon support structures.

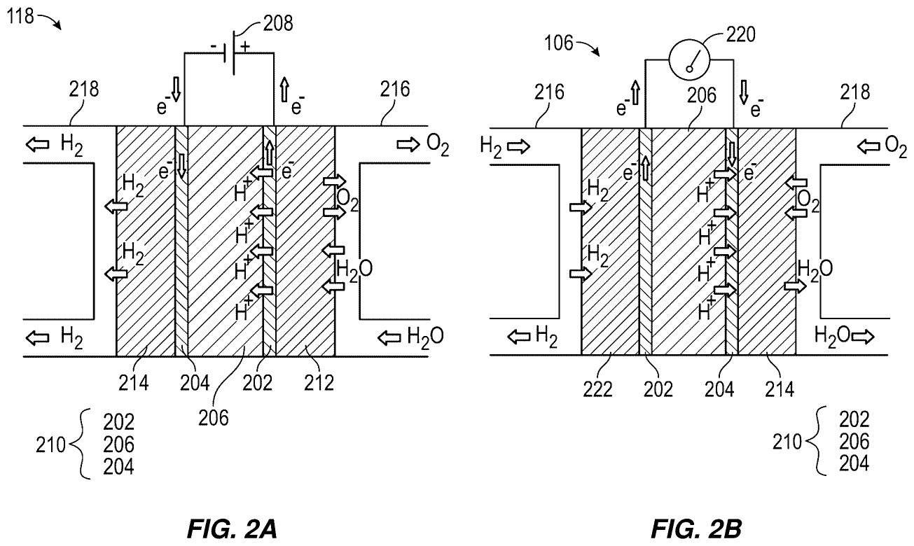

FIG. 2A depicts an electrolyzer 118 in accordance with one or more embodiments. As shown in FIG. 2A, electrolyzer 118 includes a proton-generating electrode (referred to as anode 202), a proton-consuming electrode (referred to as cathode 204), and a proton exchange membrane 206 (or simply, membrane 206) between the anode 202 and the cathode 204. The combination of the anode 202, membrane 206, and the cathode 204 together define a membrane electrode assembly (MEA) 210.

In an electrolyzer type configuration, protons (H⁺) are generated in the anode 202 and are passed through the membrane 206 to the cathode 204. More specifically, anode 202 is responsible for the oxidation of water molecules during the electrolysis process, producing oxygen gas, protons (H⁺), and electrons, while cathode 204 is responsible for the reduction of protons (H⁺) and electrons to form hydrogen gas during the electrolysis process. The protons generated at the anode 202 pass through the membrane 206 to the cathode 204. The cathode 204 facilitates the efficient combination of protons, which have passed through the membrane 206 from the anode 202, with electrons that have traveled through an external circuit (e.g., power source 208). In some embodiments, the anode 202 (the anode) and cathode 204 (the cathode) are coupled to a power source 208 which supplies a current across the anode 202 and cathode 204 so that water fed to the electrolyzer 118 can be split into hydrogen and oxygen.

In some embodiments, electrolyzer 118 includes a porous transport layer (PTL) 212 on the anode 202 and a gas diffusion layer (GDL) 214 (sometimes referred to as a diffusion media, or DM) on the cathode 204.

PTL 212 facilitates a uniform distribution of reactant fluids, typically water, across the anode 202 and to membrane 206. PTL 212 also facilitates the efficient removal of by-products such as oxygen gas from electrolyzer 118. In some embodiments, PTL 212 is made of materials that offer a combination of high electrical conductivity, chemical stability, mechanical strength, and porosity, such as, for example, sintered titanium, stainless steel, and nickel-based materials such as nickel foam. In some embodiments, PTL 212 is connected via flow channels and headers (not separately indicated) to a flow field 216. In some embodiments, flow field 216 serves as the entry point(s) to the anode 202 and membrane 206 for reactant fluid, typically water, which is necessary for the electrochemical reactions occurring within the MEA 210. Conversely, flow field 216 can include or one more outtake headers (not separately indicated) to ensure the efficient evacuation of oxygen and excess water from electrolyzer 118.

GDL 214 facilitates the collection and expulsion of hydrogen gas generated in the MEA 210. In some embodiments, GDL 214 is connected via flow channels and headers (not separately indicated) to a flow field 218. In some embodiments, flow field 218 serves as the exit point(s) for hydrogen gas formed in MEA 210. In some embodiments, GDL 214 is made of materials that offer a combination of high electrical conductivity, chemical stability, mechanical strength, and porosity, such as, for example, carbon fiber paper, carbon cloth, and other carbon-based materials.

In some embodiments, the membrane 206 is a solid polymer electrolyte that conducts protons (H⁺) while acting as an insulator for electrons, ensuring that the protons generated at the anode 202 can pass through to the cathode 204 while preventing the mixing of product gases. In some embodiments, the anode 202 and/or cathode 204 are catalyst layers attached (laminated to or directly coated) on both sides of the membrane 206. The anode 202 and/or cathode 204 can include finely dispersed catalytic particles, such as platinum (Pt) or iridium (Ir), supported on carbon particles. These catalyst layers facilitate the electrochemical reactions: at the anode 202, water molecules are oxidized to produce oxygen gas, protons, and electrons, while at the cathode 204, protons and electrons combine to form hydrogen gas. In some embodiments, the anode 202 contains finely dispersed catalyst particles such as iridium (Ir) and/or titanium oxide particles, while the cathode 204 contains finely dispersed catalyst particles such as platinum (Pt), supported by carbon particles. The catalyst layers can be coated on the membrane 206, coated on the PTL 212, coated on the GDL 214, and/or decal transferred to any or all of membrane 206, PTL 212, and GDL 214.

FIG. 2B depicts a fuel cell 106 in accordance with one or more embodiments. Fuel cell 106 is configured similarly to the electrolyzer 118 discussed with respect to FIG. 2A, except that, in a fuel cell type configuration, the anode 202 and cathode 204 are coupled to a load 220 (e.g., an electric motor, etc., such as the electric motor 114 of FIG. 1) which is powered via a current generated by the fuel cell 106 and the PTL 212 is replaced by a second GDL 222. Current is generated within fuel cell 106 due to the reaction of hydrogen gas with oxygen, producing water. Specifically, hydrogen is oxidized at the anode 202, conducting electrons through the load 222, and conducting protons through the membrane 206. During this process oxygen is reduced at the cathode 204 to form water.

As shown in FIG. 2B, fuel cell 106 includes an anode 202, a cathode 204, and a membrane 206 between the anode 202 and the cathode 204. The combination of anode 202, membrane 206, and cathode 204 together define an MEA 210. In a fuel cell type configuration, these components work together to convert chemical energy from hydrogen and oxygen into electrical energy through electrochemical reactions, as opposed to the electrolyzer configuration in FIG. 2A, which uses electrical energy to split water into hydrogen and oxygen. In the fuel cell configuration, the anode 202 is where hydrogen gas (H₂) is supplied and oxidized. The protons generated at the anode 202 pass through the membrane 206 to the cathode 204, while the electrons are conducted away from the anode 202, creating an electric current that can be used to power the load 220. In this configuration, the cathode 204 is where oxygen gas (O₂) is supplied and reduced. At the cathode 204, the protons (H⁺) that have passed through the membrane 206 combine with the electrons (e⁻) that have traveled through the load 220 and with oxygen molecules to form water (H₂O). GDL 214 and flow field 218 facilitate the transport of oxygen (typically as air) into MEA 210 and the removal of water from the fuel cell 106. Conversely, GDL 222 and flow field 216 facilitate the transport of hydrogen gas into MEA 210 and the removal of excess hydrogen gas from the fuel cell 106.

FIG. 3A depicts a protonation process 300 for forming a protonated support matrix for electrolyzer (e.g., electrolyzer 118 of FIG. 2A) and fuel cell (e.g., fuel cell 106 of FIG. 2B) membranes in accordance with one or more embodiments. The protonation process 300 can be operated as a batch or continuous process, as desired. As shown in FIG. 3A, in some embodiments, the protonation process 300 begins at step 301 with the preparation of a support matrix 302.

Support matrix 302 can be made of a range of suitable PEM support materials, such as, for example, non-fluorinated or partially fluorinated hydrocarbon materials. While not meant to be particularly limited, example non-fluorinated hydrocarbon materials include poly(ether ether ketone) (PEEK) and polysulfone (PSU). Examples of partially fluorinated hydrocarbon materials include poly(vinylidene fluoride) (PVDF) and poly(tetrafluoroethylene-co-hexafluoropropylene) (FEP). These materials can be selected based on their mechanical properties, chemical stability, and compatibility with the desired proton exchange membrane to enhance the overall performance of the underlying fuel cells and electrolyzers. In some embodiments, support matrix 302 includes one or both of PEEK and PSU. Support matrix 302 can have woven or non-woven porous structures, as desired. For example, woven structures may include materials such as woven PEEK fibers or woven PSU fibers, which can be interlaced to form a mesh-like structure. Non-woven structures, on the other hand, may include materials such as non-woven PEEK mats or non-woven PSU mats, which are formed by bonding fibers together randomly or in a specific pattern without weaving. Support matrix 302 can have a uniform or non-uniform pore size distribution, as desired. For example, a uniform pore size distribution may be achieved using precisely controlled manufacturing processes to create consistent pore sizes throughout the support matrix 302, such as in the case of sintered PEEK or PSU materials. A non-uniform pore size distribution, on the other hand, may be achieved by using techniques that create a range of pore sizes within the support matrix 302, such as electrospinning or phase separation methods.

In some embodiments, before sulfonation, the support matrix 302 undergoes a surface cleaning process to remove any contaminants or impurities. This can be done using solvents, detergents, or other cleaning agents, as desired. In some embodiments, the cleaned support matrix 302 is dried to remove any residual cleaning agents and moisture prior to sulfonation.

As will be described in further detail herein, the support matrix 302 can undergo chemical protonation (refer to step 304) or physical protonation (refer to step 306). In other words, step 301 can be followed by a chemical protonation step 304 or, alternatively, by a physical protonation step 306. Steps 304 and 306 will be described successively herein.

In some embodiments, the sulfonation process itself involves, at step 304, treating the support matrix 302 with a sulfonating agent to introduce sulfonic acid groups (e.g., —SO₃H groups, or other H+donating functional groups) onto the surface of the hydrocarbon material of the support matrix 302. Specifically, step 304 results in the formation of protonated support matrix 308a with chemically bound functional groups 310. In other words, step 304 results in a chemical protonation of the support matrix 302. As used herein, chemical protonation refers to the attachment of a material through covalent interactions (e.g., electron sharing). Sulfonation can be achieved using concentrated sulfuric acid (H₂SO₄) and/or other sulfonation reagents. In some embodiments, the support matrix 302 is immersed in a sulfonating agent (e.g., H₂SO₄) for a predetermined duration, which can vary depending on the desired level of sulfonation. The concentration of the sulfonating agent, reaction time, temperature, and pressure can also be increased or decreased to achieve the desired degree of surface protonation. More specifically, increasing the concentration of the sulfonating agent (e.g., concentrated sulfuric acid) will generally lead to a higher degree of sulfonation as a more concentrated solution provides a greater number of sulfonating species available to react with the hydrocarbon material, resulting in more sulfonic acid groups being introduced onto the surface. Conversely, decreasing the concentration of the sulfonating agent will result in a lower degree of sulfonation as there will be fewer sulfonating species available. Extending the duration of the sulfonation reaction allows more time for the sulfonating agent to interact with the hydrocarbon material, resulting in a higher degree of sulfonation, whereas decreasing the reaction time tends to reduce the exposure of the hydrocarbon material to the sulfonating agent. Higher temperatures generally accelerate the sulfonation reaction by increasing the kinetic energy of the molecules involved. This can enhance the reactivity of the sulfonating agent, leading to a higher degree of sulfonation and more sulfonic acid groups on the surface. On the other hand, lower temperatures slow down the reaction kinetics, reducing the reactivity of the sulfonating agent. This results in a lower degree of sulfonation, as the reaction proceeds more slowly and fewer sulfonic acid groups are introduced onto the surface. Higher pressures can increase the concentration of the sulfonating agent in contact with the hydrocarbon material, potentially enhancing the sulfonation reaction. This can lead to a higher degree of sulfonation and more sulfonic acid groups on the surface. Conversely, lower pressures reduce the concentration of the sulfonating agent in contact with the hydrocarbon material, which can diminish the sulfonation reaction. This results in a lower degree of sulfonation and fewer sulfonic acid groups on the surface. In any case, during the sulfonation reaction, the sulfonating agent(s) react with the hydrocarbon material in the support matrix 302, introducing sulfonic acid groups. This results in an increase in proton density at the surface of the protonated support matrix 308a, enhancing its proton conductivity. Notably, before and after the sulfonation process, the appearance of the support matrix 302 and/or protonated support matrix 308a may not change. However, the sulfonation process results in a chemical protonation of the support matrix 302 that can be characterized using, for example, X-ray fluorescence (XRF) and energy dispersive X-ray (EDX), to detect the presence of SO₃H or other proton donating functional groups (e.g., micro scale detection).

In some embodiments, the sulfonation process involves, at step 306, physically protonating the support matrix 302 by immersing the support matrix 302, at step 306, in a diluted ionomer. As used herein, physical protonation, in contrast to chemical protonation (refer to step 304) refers to the attachment of a material through non-covalent interactions. These interactions can include hydrogen bonding, van der Waals forces, electrostatic interactions, and/or physical entrapment within a material's matrix. In some embodiments, the support matrix 302 is treated, at step 306, with an ionomer dispersion (also referred to as an ionomer solvent). The ionomer dispersion (not separately indicated) can be made from materials such as perfluorosulfonic acid (PFSA), sulfonated PEEK (SPEEK) or other suitable ionomers. In some embodiments, treatment via ionomer dispersion results in the formation of a of protonated support matrix 308b with physically bound functional groups 312. While not meant to be particularly limited, the physically bound functional groups 312 can include, for example, physically bound ionomer molecules such as —R—SO₃H.

Additionally, or alternatively, protonation of the support matrix 302 can occur using other processes, such as, for example, via a plasma treatment or via x-ray irradiation. For example, the support matrix 302 (or the fibers which will make up the support matrix 302) can be exposed to a plasma environment, which is a partially ionized gas containing ions, electrons, and, optionally, neutral species. During a plasma treatment reactive sites in the matrix fibers can react with the plasma species to form new functional groups, such as hydroxyl (—OH) or carboxyl (—COOH) groups, which can enhance the proton conductivity of the support matrix 302. While not meant to be particularly limited, plasma treatments can include, for example, oxygen plasma treatments, hydrogen plasma treatments, and mixed gas plasma treatments. In another example, the support matrix 302 (or the fibers which will make up the support matrix 302) can be subjected to x-ray irradiation. Exposure to relatively high-energy X-ray photons can cause ionization and the formation of reactive species within the matrix fibers. These reactive species can lead to the breaking of chemical bonds and the formation of new functional groups, such as hydroxyl (—OH) or carboxyl (—COOH) groups, which can enhance the proton conductivity of the support matrix 302. X-ray irradiation can be fine-tuned by adjusting the X-ray dose, exposure time, environmental conditions, etc., to achieve a desired level of surface modification (e.g., protonation).

After the sulfonation reaction is complete (chemical, physical, or otherwise), the sulfonated support matrix 302 is removed from the sulfonating agent (e.g., sulfonic acid groups, diluted ionomer, etc.). In some embodiments, support matrix 302 is rinsed using, for example, deionized water, to remove any residual acids or by-products. In some embodiments, the sulfonated support matrix 302 may undergo a neutralization step to ensure that any remaining acidic groups are neutralized. This can be done using a neutralizing agent such as sodium hydroxide (NaOH) or ammonium hydroxide (NH₄OH). In some embodiments, the neutralized support matrix 302 is then rinsed again with deionized water to remove any residual neutralizing agent. In some embodiments, the sulfonated and neutralized support matrix 302 is dried to remove any remaining moisture. This can be done using an oven or a vacuum drying process, as desired.

Additionally, or alternatively, protonation can occur prior to, or while, manufacturing the support matrix 302. In this case, protonation processes (e.g., chemical, physical, plasma, x-ray irradiation, etc., as discussed previously herein, refer to steps 304 and 306) can be applied directly to the fibers (not separately indicated) used to produce the support matrix 302. In other words, protonation can occur before the support matrix 302 is produced, after the support matrix 302 is produced, or both before and after the support matrix 302 is produced.

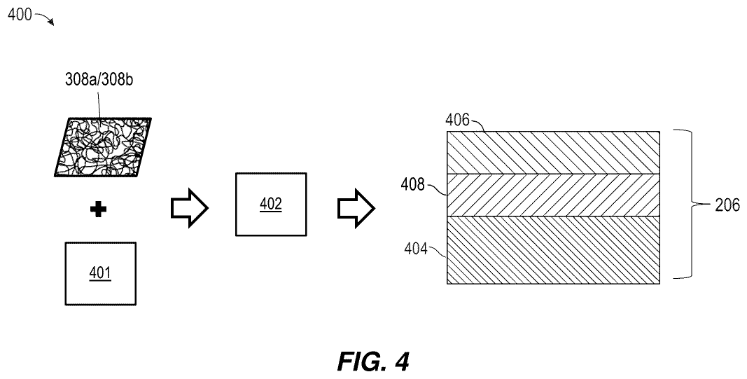

As shown in FIG. 3A, the sulfonation process, chemical or physical, results in the creation of protons (either chemically bound functional groups 310 or physically bound functional groups 312, respectively) on a surface (not separately indicated) of the support matrix 302. Protons created at the surface of the protonated support matrix 308a or 308b increase surface hydrophilicity, facilitating ionomer imbibement and easing the PEM fabrication process (refer to FIG. 4). The protons created at the surface of the protonated support matrix 308a and 308b also increase the proton density of the resulting PEMs, improving membrane proton conductivity and fuel cell or electrolyzer performance (depending on implementation).

FIG. 3B depicts an example protonation reaction for chemical sulfonation based processes (refer, e.g., to FIG. 3A step 304) in accordance with one or more embodiments. As shown in FIG. 3B, a PEM support material (here, PEEK) undergoes sulfonation (resulting in surface protonation) to form a sulfonated PEEK (or SPEEK). During this process, the hydrogen (H) of one or more benzene functional groups in the PEEK are replaced with sulfonic acid (—SO₃H) functional groups. Notably, the accessibility of the hydrogen in sulfonic acid functional group is greater than the accessibility of the hydrogen when constrained to the benzene functional group. In other words, the sulfonated PEM support material can be thought of as a surface protonated hydrocarbon support structure.

FIG. 4 depicts a process 400 for forming a PEM 206 with a surface protonated hydrocarbon support, and filled ionomer serving as a reinforcement layer for electrolyzer (e.g., electrolyzer 118 of FIG. 2A) and fuel cell (e.g., fuel cell 106 of FIG. 2B) membranes in accordance with one or more embodiments. The process 400 can be operated as a batch or continuous process, as desired. As shown in FIG. 4, the isomer immersion process 400 begins with the preparation of a protonated support matrix 308a or 308b (refer to FIG. 3A) and an ionomer solution 401.

In some embodiments, before protonation, the protonated support matrix 308a or 308b undergoes a surface cleaning process to remove any contaminants or impurities. This can be done using solvents, detergents, or other cleaning agents, as desired. In some embodiments, the protonated support matrix 308a or 308b is dried to remove any residual cleaning agents and moisture prior to sulfonation.

As further shown in FIG. 4, the protonated support matrix 308a or 308b and ionomer solution 401 are combined and processed in a PEM fabrication step 402 to define a membrane 206. In some embodiments, step 402 involves coating the protonated support matrix 308a or 308b with a first layer of ionomer solution, followed by imbibing the first ionomer solution into the protonated support matrix, and then coating the protonated support matrix with a second coating of ionomer solution (not separately indicated). The second ionomer solution may or may not be of a same ionomer material as the first layer of ionomer solution. The resulting bottom ionomer layer 404 and top ionomer layer 406 can include materials such as perfluorosulfonic acid (PFSA), sulfonated PEEK (SPEEK) or other suitable ionomers dispersed in proper solvents, such as mixture of water, alcohol and or other organic solvents. As shown in FIG. 4, the result of step 402 is the formation of a membrane 206 having three layers: a bottom ionomer layer 404, a top ionomer layer 406, and reinforcement layer 408 (also referred to as an ionomer filled surface protonated porous hydrocarbon reinforcement layer). In some embodiments, the process 400 may include multiple layers coating before and/or after the imbibement process. The membrane fabrication process may also include a heat treatment, characterization (thickness monitoring, defect checking etc.) in between and/or after each of the coating and imbibement processes. The membranes can be produced on top of a backing substrate, or directly on electrode layers, or electrode layers on top of a gas diffusion layer.

In some embodiments, the membrane 206 is formed on a backing substrate and/or electrode layer (not separately indicated) prior to, during, or after, the introduction of the ionomer solution 401. While not meant to be particularly limited, a backing substrate can include, for example, glass, polymer films (e.g., polyethylene terephthalate (PET), polyimide (PI), polypropylene (PP), polyethylene (PE), polyvinylidene fluoride (PVDF), etc.), metal foils (e.g., aluminum foil, stainless steel foil, copper foil, nickel foil, etc.), ceramics (e.g., alumina, zirconia, silicon carbide, etc.), composites (e.g., glass-fiber reinforced polymers, carbon-fiber polymers, etc.), silicon wafers, etc. An electrode layer, if present, can include any suitable anode or cathode electrode materials such as, for example, platinum, iridium, ruthenium, nickel, palladium, cobalt, iron, oxides thereof (e.g., iridium oxide), alloys thereof (e.g., nickel-iron alloys), and combinations thereof.

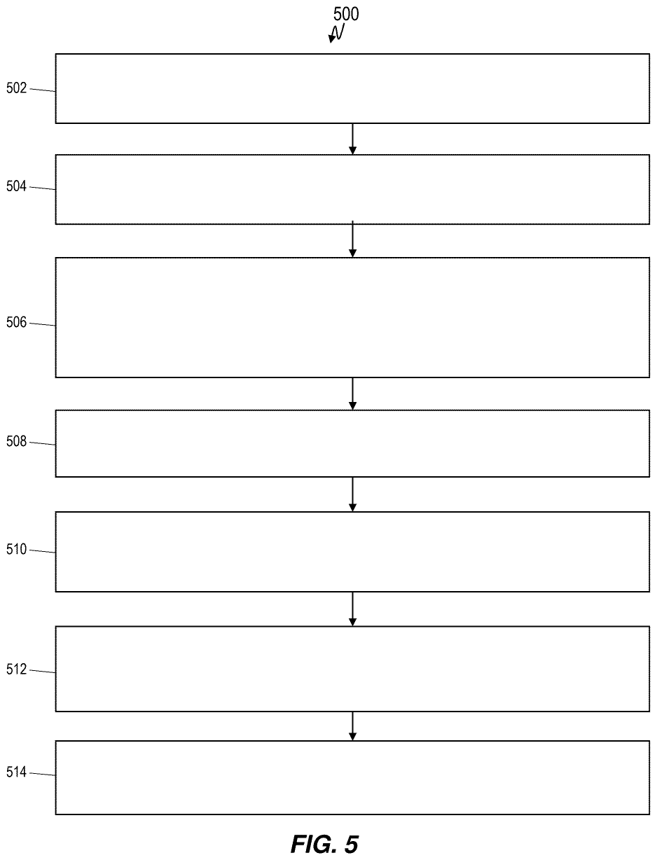

Referring now to FIG. 5, a flowchart 500 for leveraging surface protonated hydrocarbon support structures for fuel cell and electrolyzer membranes is generally shown according to an embodiment. The flowchart 500 is described in reference to FIGS. 1-4 and may include additional steps not depicted in FIG. 5. Although depicted in a particular order, the blocks depicted in FIG. 5 can be rearranged, subdivided, and/or combined.

At block 502, the method includes forming a proton-generating electrode including an anode.

At block 504, the method includes forming a proton-consuming electrode including a cathode.

At block 506, the method includes forming a proton exchange membrane positioned between the proton-generating electrode and the proton-consuming electrode. The proton-generating electrode, proton-consuming electrode, and proton exchange membrane collectively define an MEA. The proton exchange membrane includes a surface protonated porous hydrocarbon reinforcement layer.

At block 508, the method includes forming an anode-side gas diffusion layer on the proton-generating electrode.

At block 510, the method includes forming a cathode-side gas diffusion layer on the proton-consuming electrode.

At block 512, the method includes coupling a first flow field to the anode-side gas diffusion layer.

At block 514, the method includes coupling a second flow field to the cathode-side gas diffusion layer.

In some embodiments, the surface protonated porous hydrocarbon reinforcement layer includes a non-fluorinated or partially fluorinated hydrocarbon support matrix with surface protonation.

In some embodiments, the surface protonated porous hydrocarbon reinforcement layer includes at least one of sulfonated poly(ether-ether-ketone) (SPEEK) and polysulfone (PSU).

In some embodiments, the non-fluorinated or partially fluorinated hydrocarbon support matrix is protonated by a sulfonation process using at least one of an acid or a sulfonation reagent.

In some embodiments, the non-fluorinated or partially fluorinated hydrocarbon support matrix is protonated by an immersing process in the presence of a diluted ionomer solution.

In some embodiments, the PEM includes a bottom ionomer layer, a top ionomer layer, and an ionomer filled porous support layer (optionally, one or more reinforcement layers) between the bottom ionomer layer and the top ionomer layer.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor;
a battery electrically coupled to the electric motor; and
a fuel cell stack including a proton exchange membrane electrochemical cell electrically coupled to at least one of the electric motor or the battery, the proton exchange membrane electrochemical cell comprising:
a proton-generating electrode comprising an anode;
a proton-consuming electrode comprising a cathode;
a proton exchange membrane positioned between the proton-generating electrode and the proton-consuming electrode, the proton-generating electrode, proton-consuming electrode, and proton exchange membrane collectively defining a membrane-electrode-assembly (MEA), the proton exchange membrane comprising a surface protonated porous hydrocarbon reinforcement layer;
an anode-side gas diffusion layer on the proton-generating electrode;
a cathode-side gas diffusion layer on the proton-consuming electrode;
a first flow field coupled to the anode-side gas diffusion layer; and
a second flow field coupled to the cathode-side gas diffusion layer.

2. The vehicle of claim 1, wherein the surface protonated porous hydrocarbon reinforcement layer comprises a non-fluorinated or partially fluorinated hydrocarbon support matrix with surface protonation.

3. The vehicle of claim 2, wherein the surface protonated porous hydrocarbon reinforcement layer comprises at least one of sulfonated poly(ether-ether-ketone) (SPEEK) and polysulfone (PSU).

4. The vehicle of claim 2, wherein the non-fluorinated or partially fluorinated hydrocarbon support matrix is protonated by a sulfonation process using at least one of an acid or a sulfonation reagent.

5. The vehicle of claim 2, wherein the non-fluorinated or partially fluorinated hydrocarbon support matrix is protonated by an immersing process in the presence of a diluted ionomer solution.

6. The vehicle of claim 1, wherein the surface protonated porous hydrocarbon reinforcement layer comprises a bottom ionomer layer, a top ionomer layer, and an ionomer filled porous support layer between the bottom ionomer layer and the top ionomer layer.

7. The vehicle of claim 6, wherein the ionomer filled porous support layer includes a porous hydrocarbon matrix, and ionomer filled in the hydrocarbon support matrix.

8. A proton exchange membrane (PEM) electrochemical cell comprising:
a proton-generating electrode comprising an anode;
a proton-consuming electrode comprising a cathode; and
a proton exchange membrane positioned between the proton-generating electrode and the proton-consuming electrode, the proton-generating electrode, proton-consuming electrode, and proton exchange membrane collectively defining a membrane-electrode-assembly (MEA), the proton exchange membrane comprising a surface protonated porous hydrocarbon reinforcement layer;
an anode-side gas diffusion layer on the proton-generating electrode;
a cathode-side gas diffusion layer on the proton-consuming electrode;
a first flow field coupled to the anode-side gas diffusion layer; and
a second flow field coupled to the cathode-side gas diffusion layer.

9. The PEM electrochemical cell of claim 8, wherein the surface protonated porous hydrocarbon reinforcement layer comprises a non-fluorinated or partially fluorinated hydrocarbon support matrix with surface protonation.

10. The PEM electrochemical cell of claim 9, wherein the surface protonated porous hydrocarbon reinforcement layer comprises at least one of sulfonated poly(ether-ether-ketone) (SPEEK) and polysulfone (PSU).

11. The PEM electrochemical cell of claim 9, wherein the non-fluorinated or partially fluorinated hydrocarbon support matrix is protonated by a sulfonation process using at least one of an acid or a sulfonation reagent.

12. The PEM electrochemical cell of claim 9, wherein the non-fluorinated or partially fluorinated hydrocarbon support matrix is protonated by an immersing process in the presence of a diluted ionomer solution.

13. The PEM electrochemical cell of claim 8, wherein the proton exchange membrane comprises a bottom ionomer layer, a top ionomer layer, and an ionomer filled porous support layer between the bottom ionomer layer and the top ionomer layer.

14. The PEM electrochemical cell of claim 13, wherein the ionomer filled porous support layer includes a porous hydrocarbon matrix, and ionomer filled in the hydrocarbon support matrix.

15. A method comprising:
forming a proton-generating electrode comprising an anode;
forming a proton-consuming electrode comprising a cathode; and
forming a proton exchange membrane (PEM) positioned between the proton-generating electrode and the proton-consuming electrode, the proton-generating electrode, proton-consuming electrode, and PEM collectively defining a membrane-electrode-assembly (MEA), the PEM comprising a surface protonated porous hydrocarbon reinforcement layer;
forming an anode-side gas diffusion layer on the proton-generating electrode;
forming a cathode-side gas diffusion layer on the proton-consuming electrode;
coupling a first flow field to the anode-side gas diffusion layer; and
coupling a second flow field to the cathode-side gas diffusion layer.

16. The method of claim 15, wherein the surface protonated porous hydrocarbon reinforcement layer comprises a non-fluorinated or partially fluorinated hydrocarbon support matrix with surface protonation.

17. The method of claim 16, wherein the surface protonated porous hydrocarbon reinforcement layer comprises at least one of sulfonated poly(ether-ether-ketone) (SPEEK) and polysulfone (PSU).

18. The method of claim 16, wherein the non-fluorinated or partially fluorinated hydrocarbon support matrix is protonated by a sulfonation process using at least one of an acid or a sulfonation reagent.

19. The method of claim 16, wherein the non-fluorinated or partially fluorinated hydrocarbon support matrix is protonated by an immersing process in the presence of a diluted ionomer solution.

20. The method of claim 15, wherein the PEM comprises a bottom ionomer layer, a top ionomer layer, and an ionomer filled porous support layer between the bottom ionomer layer and the top ionomer layer.
